(19) United States
(12) Patent Application Publication
(10) Pub. No.: US 2026/0165267 A1
(43) Pub. Date: Jun. 18, 2026

(54) SYSTEM AND METHOD FOR CULTIVATING DUCKWEED

(71) Applicant: SIGNIFY HOLDING B.V., EINDHOVEN (NL)

(72) Inventors: MARCELLINUS PETRUS CAROLUS MICHAEL KRIJN, EINDHOVEN (NL); LEONIE MARIA GEERDINCK, EINDHOVEN (NL); CELINE CATHERINE SARAH NICOLE, EINDHOVEN (NL); SILVIA MARIA BOOIJ, EINDHOVEN (NL); LAMBERTUS ADRIANUS MARINUS DE JONG, SON (NL); MAURICE ALEXANDER HUGO DONNERS, WAALRE (NL)

(21) Appl. No.: 19/126,327

(22) PCT Filed: Nov. 2, 2023
(86) PCT No.: PCT/EP2023/080532

§ 371 Date: May 1, 2025

(30) Foreign Application Priority Data
Nov. 8, 2022 (EP) 22206136.8

(51) Int. Cl. G06N 20/00

(52) U.S. Cl. CPC A01G 33/00; A01G 7/045

(57) ABSTRACT

A system is disclosed for cultivating duckweed. The system comprises an illumination system that is configured to illuminate to-be-harvested duckweed in a pre-harvest area and a duckweed properties measurement system that is configured to determine one or more properties of the to-be-harvested duckweed. The system also comprises a data processing system that is configured to, based on the determined one or more properties of the to-be-harvested duckweed, determine a pre-harvest light recipe. The data processing system is further configured to cause the illumination system to illuminate the to-be-harvested duckweed in the pre-harvest area in accordance with the determined pre-harvest light recipe.

### FIELD OF THE INVENTION

This disclosure relates to a system for cultivating duckweed, in particular to such system wherein a pre-harvest light recipe is determined for to-be-harvested duckweed based on one or more measured properties of the to-be-harvested duckweed. This disclosure further relates to a computer-implemented method for illuminating to-be-harvested duckweed and to a computer program and computer-readable storage medium for performing such method.

### BACKGROUND

Duckweed is a small aquatic plant that is rich in protein, attracting a lot of attention recently since it is considered a main candidate to enable the transition from animal-based proteins to plant-based proteins. For food safety and human consumption, it has to be grown in controlled environments such as greenhouses and vertical farms. Its value largely depends on its nutritional content (mainly the composition and amount of amino acids in the proteins).

There are four families of duckweed; Lemna, Spirodela, Wolfia and Wolffiella. About 40 species are known worldwide. All of them have flat tiny, leaflike oval to round “fronds” from about 1 mm to less than 10 mm across. Some species develop root-like structures which either stabilise the plant or assist to obtain nutrients where these are in dilute concentrations.

As each frond matures, it begins producing new buds in the meristematic zone near the centre of the frond. These buds grow into new fronds while still attached to the parent frond. When they mature, they break off. At this point, they have likely already begun producing fronds of their own. This cycle of reproduction allows duckweed to have a very fast rate of growth. It is capable of doubling in biomass over the course of 16-24 hours. The protein production can be as much as 6× higher per hectare as compared to soybeans, for example. The amino acid composition of the proteins in duckweed mainly determines the nutritional value.

In light of the opportunities that duckweed may provide, there is a continuous striving in the art for improving the yield of duckweed farms, in particular in terms of the duckweed's nutritional content.

### SUMMARY

To that end, a system is disclosed for cultivating duckweed. The system comprises an illumination system that is configured to illuminate to-be-harvested duckweed and a duckweed properties measurement system that is configured to measure and/or determine one or more properties of the to-be-harvested duckweed. The system also comprises a data processing system that is configured to, based on the measured and/or determined one or more properties of the to-be-harvested duckweed, determine a pre-harvest light recipe. The data processing system is further configured to cause the illumination system to illuminate the to-be-harvested duckweed in accordance with the determined pre-harvest light recipe.

The growth of the duckweed, as well as its nutritional content can be influenced by light. Unfortunately, however, light that stimulates growth of the duckweed, also referred to herein as grow light, does not necessarily cause an increase of nutritional content. Also, light that increases nutritional content does not necessarily stimulate duckweed growth. Therefore, growth light may be provided to the duckweed in early phases of its development in order to boost growth, while the nutritional content increasing light may be provided just before harvest in order to boost the nutritional content of the duckweed that is going to be harvested. The earlier phases of duckweed development are referred to as the growth phase, the time period just before harvest is referred to as the pre-harvest phase. In this context, nutritional content increasing light provided relatively short before harvesting is also referred to herein as pre-harvest light. Pre-harvest light is generally different from growth light used to stimulate growth of duckweed in a growth phase prior to the pre-harvest phase. A complication with duckweed, however, is that it reproduces very fast so that duckweed that is going to be harvested can consist of duckweed having varying properties, not least because the to-be-harvested duckweed will typically consist of duckweed having varying ages.

To add to this, the inventors found that there is no single, optimal pre-harvest light recipe for duckweed having whatever properties. On the contrary, as to what constitutes an effective pre-harvest light recipe, for example in the sense that the pre-harvest light recipe causes a substantial increase of the nutritional content of the to-be-harvested duckweed, depends on the properties of the duckweed that is actually going to be harvested. Hence, by taking into account the properties of specifically the duckweed that is going to be harvested, instead of the properties of an entire batch of duckweed which would include duckweed that is not going to be harvested in the near future, more effective pre-harvest light recipes can be determined. The pre-harvest light recipes that are determined in accordance with embodiments described herein, are thus tailored specifically to the duckweed that is going to be harvested and thus can be aimed specifically at improving the to-be-harvested duckweed, for example by increasing its nutritional value. Thus, the technologies disclosed herein improve the harvest yield.

A batch of duckweed that is being grown in a duckweed growing system may be understood to, at any given time, consist of duckweed that will inevitably be harvested and other duckweed. For example, it may be that the duckweed growing system is configured to cause a continuous, circular flow of the duckweed, and that somewhere in the circular system part of the flow is branched off to a harvesting system. In such case, the duckweed that has branched off will inevitably be harvested. After all, it will inevitably end up at/in the harvesting system. Hence, the duckweed that has branched off may be understood as the to-be-harvested duckweed as opposed to the duckweed that has not branched off and that still flows in the circular system. In another example, it may be that the duckweed growing system is configured to cause the duckweed to stay quasi stationary on a water surface such in as in a tank, a pool or a pond and the harvesting system is configured to be moveable and move to a location where duckweed is to be harvested.

Additionally or alternatively, to-be-harvested duckweed may be understood as duckweed that is going to be harvested within a predetermined amount of time, e.g., within the next 48 hours. The pre-harvest light treatment may last 6 hours or more, e.g., 24 hours or more. The to-be-harvested duckweed can be the duckweed that is going to be harvested within a time that is equal to or longer than the (remaining) duration of the pre-harvest light treatment.

The term “to-be-harvested duckweed” may be understood to be duckweed that is present at a location immediately preceding a location of a harvesting system in a duckweed flow direction, e.g., as branched off from a circulating flow of duckweed in a raceway-based growth system, and/or is duckweed that is going to be harvested within a predetermined amount of time. The location may also be an area immediately preceding the harvesting station in a duckweed flow direction and may then be referred to as a pre-harvest area. The pre-harvest area where the to-be-harvested duckweed receives the pre-harvest light is different from a growth area where (other) duckweed may receive growth light. The pre-harvest area typically is substantially smaller than the growth area in the duckweed growth system. Additionally or alternatively, the to-be-harvested duckweed is duckweed that is going to be harvested within a predetermined amount of time, which predetermined amount of time typically is substantially shorter than an average dwell time of duckweed in the duckweed growth system which comprises the growth phase of the duckweed in the growth system. The average dwell time of duckweed in the duckweed growth system may be deduced from an average flow rate of duckweed through the duckweed growth system, e.g., through a circulating raceway system, or from an average duration of time between an influx of duckweed in the growth system and a harvest of duckweed from the growth system.

Red light, which may be understood as light having a wavelength between 600-750 nm, may be used as grow light, and blue light, which may be understood as light having a wavelength between 400-500 nm, may be used as nutritional value increasing light.

The to-be-harvested duckweed is typically present as a duckweed layer on a water surface. In an embodiment, the one or more properties of the to-be-harvested duckweed comprise at least one of
a thickness of the duckweed layer,
an amount, e.g., a number, of duckweed plants per surface area,
a morphology of the to-be-harvested duckweed,
a size or size distribution of the to-be-harvested duckweed,
a texture of the to-be-harvested duckweed,
an amount of chlorophyll in the to-be-harvested duckweed,
an amount of carotenoid in the to-be-harvested duckweed,
an amount of flavonoid in the to-be-harvested duckweed.

This embodiment is beneficial in that (a selection of) these properties at least to some extent determine what is a good pre-harvest light recipe.

Typically, for a larger layer thickness or a larger amount of duckweed plants per surface area, a higher pre-harvest light integral (i.e., the total amount of light integrated over the pre-harvest lighting period) is needed to achieve a certain effect. This is especially the case when the duckweed plants are stacked on top of each other.

In examples, the pre-harvest light can also be used to achieve a uniform layer thickness. For example, the pre-harvest light may increase growth (relative to a default growth light recipe) if the layer thickness is below a predetermined value and may reduce growth if the layer thickness is above a predetermined value. This can be the case if there is a variable amount of daylight. For example, more or longer pre-harvest light may be applied during or after dark days, and less during or after bright days, in order to achieve a consistent layer thickness.

Similarly, the pre-harvest light can be used to achieve a more uniform size of the to-be-harvested duckweed. The pre-harvest light integral of growth stimulating light may be increased when the size is below a certain value and may be decreased when the size is above a certain value. The size can be a statistically representative size of a size distribution, e.g., a mean, median, minimum, or maximum size. This may be the case when there is a variable amount of daylight. For example, more or longer pre-harvest light may be provided at dark days and less at bright days.

Pre-harvest light can be used to make the duckweed more crispy (having a more firm texture), by using UV light. The effect of UV light is to harden the cell walls.

Thus, the amount of UV light may be adjusted based on a comparison of the measured texture and a desired texture.

Carotenoids and flavonoids are in general antioxidants and considered very healthy compounds. Their amount can be increased by applying an abiotic stress to the duckweed plants. Such stress response can be provoked by applying pre-harvest light with a high light intensity level (e.g., exceeding 100 μmol/m2 /s) and a high blue fraction (e.g., exceeding 10% of the total amount of light). Similarly, the amount of chlorophyl can be increased by the application of pre-harvest light with a high blue fraction (for example, an amount of blue light exceeding 10% of the total amount of light). Thus, the pre-harvest light recipe may be determined or adjusted based on measured (and desired) carotenoid, flavonoid, and/or chlorophyll levels.

The measured morphology of the to-be-harvested duckweed may for example be the morphology, e.g., shape, that was measured the most in the plant population of the to-be-harvested duckweed. The measured morphology may also be indicative of a histogram indicating how many times which morphology was measured in the to-be-harvested duckweed. As an example, flowering implies a change in morphology. Flowering can be promoted by means of a pre-harvest light treatment. For example, Lemna gibba is a long-day plant and will start flowering when offering pre-harvest light with a long(er) photoperiod.

Likewise, the measured size or texture may for example be, respectively, the size or texture that was measured the most in the population of the to-be-harvested duckweed. The measured size or texture may also be indicative of a histogram indicating how many times which size or texture, respectively, was measured in the to-be-harvested duckweed.

In an advantageous embodiment, some of the properties may be measured using an imaging system, especially the properties that are visible with the naked eye. Such embodiment may comprise recording an image of the to-be-harvested duckweed and analyzing the recorded image using known image analyses techniques in order to determine one or more properties, such as morphology and/or texture.

In an embodiment, the system comprises a harvesting system that is configured to harvest the to-be-harvested duckweed. In such embodiment, the data processing system may be configured to cause the harvesting system to harvest the to-be-harvested duckweed after the to-be-harvested duckweed has been illuminated in accordance with the pre-harvest light recipe.

In an embodiment, the illumination system is configured to not illuminate other duckweed other than the to-be-harvested duckweed. Additionally or alternatively, the data processing system is configured to cause the illumination system to not illuminate other duckweed other than the to-be-harvested duckweed in accordance with the pre-harvest light recipe.

Thus, only the duckweed that is going to be actually harvested will receive lighting in accordance with the determined pre-harvest light recipe. The other duckweed may receive another type of illumination, for example regular grow light. This is advantageous in that a pre-harvest light recipe may not be necessarily beneficial for the growth of the duckweed. Hence, this embodiment allows the growth of other duckweed, other than the to-be-harvested duckweed, to be boosted using some grow light recipe, while at the same time boost for example the nutritional content of the to-be-harvested duckweed using the pre-harvest light recipe.

The illumination system may be configured to not illuminate other duckweed in that the illumination system only comprises light sources directed at the to-be-harvested duckweed. To illustrate, the illumination system may comprise only light sources that are above an area where the to-be-harvested duckweed is, for example an area near and/or adjacent a harvesting system.

It may also be that there is one illumination system having a plurality of light sources that can illuminate an entire batch of duckweed, namely both the to-be-harvested duckweed and the other duckweed. In such case, the data processing system may be configured to cause only light sources that emit light onto the to-be-harvested duckweed to follow the pre-harvest light recipe, while the data processing system may cause other light sources to for example follow a grow light recipe.

In an embodiment, the duckweed properties measurement system comprises an imaging system that is configured to capture an image of the to-be-harvested duckweed. In such embodiment, the duckweed properties measurement system may comprise a second data processing system that is configured to determine the one or more properties of the duckweed based on the captured image.

This embodiment is advantageous in that it allows for accurate and fast measurement of relevant duckweed properties.

The data processing configured to determine the pre-harvest light recipe and the second data processing system configured to determine the one or more properties of the duckweed may be embodied as a single data processing system. Thus, such single data processing system may be a computer that is configured to both analyze the image as captured by the imaging system in order to determine the one or more properties and to determine the pre-harvest light recipe based on the determined one or more properties.

The second data processing system may be configured to analyze the captured image in order to determine the duckweed properties. Computer-vision techniques known in the art are for example used by the second data processing system for determining the one or more properties of the duckweed based on the captured image.

In an embodiment, the second data processing system is configured to determine, based on the captured image, one or more characteristics of the to-be-harvested duckweed, wherein the one or more characteristics comprise at least one of
an amount of the to-be-harvested duckweed,
a size of the to-be-harvested duckweed,
a color of the to-be-harvested duckweed.

In such embodiment, the second data processing system may be configured to determine the one or more duckweed properties based on the one or more characteristics.

This embodiment improves the accuracy with which the one or more properties of the to-be-harvested duckweed can be determined, and thus enables to determine a pre-harvest light recipe that is more effective, e.g., in terms of boosting the nutritional content of the to-be-harvested duckweed.

To illustrate, an age of an individual plant of duckweed can be estimated based on its size. Therefore, the characteristic “size” can be determined by performing image analysis on the captured image and the duckweed property “age” can then be determined based on the size. In turn, the pre-harvest light recipe can than advantageously be determined based on the determined age (distribution) of the to-be-harvested duckweed.

In an embodiment, the pre-harvest light recipe defines, for a particular time period, one or more properties of light provided to the to-be-harvested duckweed. The one or more properties of light comprise at least one of:
a radiant power of the light as generated by the illumination system, and
a radiant power of the light as received by the to-be-harvested duckweed,
an electromagnetic spectrum of the light generated by the illumination system, and
a variation of the radiant power and/or the radiant flux and/or the electromagnetic spectrum within the particular time period.

These properties of light are known to influence the (development of) growth and/or nutritional content in duckweed. Hence, by tailoring specifically these properties to the duckweed properties, effective pre-harvest light recipes may be obtained, which lead to higher yields.

Preferably, the pre-harvest light recipe defines which light is provided when during the particular time period. Preferably, the particular time period runs substantially until the time of harvest.

The radiant power of the light as received by the to-be-harvested duckweed may be expressed as an irradiance received by the to-be-harvested duckweed.

In an embodiment, the data processing system is configured to cause the illumination system to generate light such that the light has the radiant power and/or the radiant flux and/or the electromagnetic spectrum and/or the variation as defined by the pre-harvest light recipe.

Typically, the data processing system is configured to cause another system, such as the illumination system or water temperature control system described below, to perform some step by generating an appropriate control signal and sending the control signal to such system, wherein the control signal causes the system to perform the desired step.

This embodiment allows automatic implementation of suitable pre-harvest light recipes.

In an embodiment, the system comprises a water temperature control system that is configured to control a temperature of water on which and/or in which the to-be-harvested duckweed is floating. The data processing system is configured to, based on the determined pre-harvest light recipe, determine a temperature for the water below the to-be-harvested duckweed and to cause the water temperature control system to cause the water to have the determined temperature.

Water temperature also influences the (development of) nutritional content in the to-be-harvested duckweed. Hence by controlling the water temperature in addition to controlling the lighting, the nutritional content of the to-be-harvested duckweed can be boosted even more.

In an embodiment, the data processing system is configured to determine the pre-harvest light recipe based on the one or more properties using a model, obtainable by performing a machine-learning method, wherein the model associates sets of duckweed properties respectively with pre-harvest light recipes.

Thus, input into such model may be a set of one or more measured and/or determined duckweed properties of an amount of to-be-harvested duckweed. Then, the model may output an effective pre-harvest light recipe for that amount of to-be-harvested duckweed. For training the model, the sets of duckweed properties may also be measured at harvest time but also post-harvest (such as immediately after harvest or, for example, one or more weeks after harvest when the objective is to optimize the shelf life of the harvested duckweed).

In an embodiment, the data processing system is configured to construct the model based on training data, wherein the training data associate a plurality of sets of one or more duckweed properties to respective pre-harvest light recipes.

The training data may comprise historical data relating to previous amounts of to-be-harvested duckweed having certain measured and/or determined properties. Such historical data may then indicate for each amount of to-be-harvested duckweed the pre-harvest light recipe that was applied to it. Preferably, the training data then also indicates an effectiveness of the pre-harvest light recipe, for example by indicating an increase of nutritional content in the amount of to-be-harvested duckweed upon application of the indicated pre-harvest light recipe. Machine learning methods known in the art may then be used to construct the model based on these training data.

One aspect of this disclosure relates to a computer-implemented method for illuminating to-be-harvested duckweed. The method comprises receiving from a duckweed properties measurements system a signal indicative of one or more properties of the to-be-harvested duckweed. The method also comprises determining, based on the one or more properties of the to-be-harvested duckweed as indicated by the signal, a pre-harvest light recipe. Further, the method comprises causing an illumination system to illuminate the to-be-harvested duckweed in accordance with the determined pre-harvest light recipe.

In an embodiment of the method, the to-be-harvested duckweed is present as a duckweed layer on a water surface. Herein the one or more properties comprise at least one of
a thickness of the duckweed layer,
an amount, e.g., a number, of duckweed plants per surface area,
a morphology of the to-be-harvested duckweed,
a size or size distribution of the to-be-harvested duckweed,
a texture of the to-be-harvested duckweed,
an amount of chlorophyll in the to-be-harvested duckweed,
an amount of carotenoid in the to-be-harvested duckweed,
an amount of flavonoid in the to-be-harvested duckweed.

The computer-implemented method described herein may comprise any of the steps as performed by the data processing system or second data processing system described herein.

One aspect of this disclosure relates to a computer program comprising instructions which, when executed by a computer, cause the computer to perform any of the methods described herein.

One aspect of this disclosure relates to a computer-readable storage medium having stored thereon any of the computer programs disclosed herein.

One aspect of this disclosure relates to a computer comprising a computer readable storage medium having computer readable program code embodied therewith, and a processor, preferably a microprocessor, coupled to the computer readable storage medium, wherein responsive to executing the computer readable program code, the processor is configured to perform any of the methods described herein.

One aspect of this disclosure relates to a computer program or suite of computer programs comprising at least one software code portion or a computer program product storing at least one software code portion, the software code portion, when run on a computer system, being configured for executing any of the methods described herein.

One aspect of this disclosure relates to a non-transitory computer-readable storage medium storing at least one software code portion, the software code portion, when executed or processed by a computer, is configured to perform any of the methods described herein.

As will be appreciated by one skilled in the art, aspects of the present invention may be embodied as a system, a method or a computer program product.

Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java(TM), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Moreover, a computer program for carrying out the methods described herein, as well as a non-transitory computer readable storage-medium storing the computer program are provided. A computer program may, for example, be downloaded (updated) to the existing systems (e.g. to the existing systems for cultivating duckweed) or be stored upon manufacturing of these systems.

Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIGS. 1A and 1B schematically illustrate systems according to embodiments,

FIG. 2 is a flow chart illustrating a method according to an embodiment,

FIG. 3 is a flow chart illustrating a method according to an embodiment, and.

FIG. 4 depicts a block diagram illustrating a data processing system according to an embodiment.

### DETAILED DESCRIPTION OF THE DRAWINGS

In the figures, identical reference numbers indicate identical or similar elements.

A property of duckweed is that it easily absorbs heavy metals and other contaminants in the water. Because of this, for human consumption, a controlled environment with clean water supply and uncontaminated fertilizers is required. Examples of such controlled environments are (semi-closed) environments such as greenhouses and vertical farms. A closed environment allows reuse of CO₂ that is produced as a by-product by energy plants, for example.

Duckweed grown under ideal circumstances has a protein content of 35-45% of the dry weight.

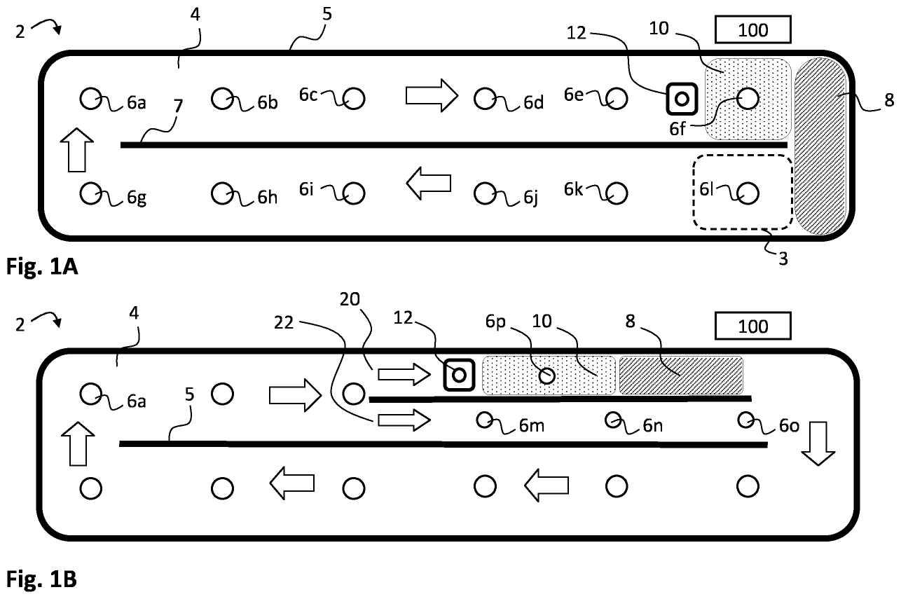

FIG. 1A schematically shows a system 2 for cultivating duckweed according to an embodiment. FIG. 1A shows a top view of such system. Duckweed floats on a water surface 4 and moves from region 3 all the way (see the arrows) to the harvesting system 8 where the duckweed is harvested. The water in the system 2 flows in the direction of the arrows thus causing the duckweed floating on the water surface to also move in the direction of the arrows. The flow of the water may be caused by pumps (not shown). The duckweed will typically reproduce and grow as it moves from region 3 to the harvesting system 8. Each frond of duckweed can divide about 10-20 times during its lifetime. Therefore, a batch of to-be harvested duckweed will consist of duckweed of different ages. Optimum growth of the duckweed occurs at (water) temperatures between 20 and 30° C. The harvesting system 8 may be configured to harvest all duckweed that passes through harvesting system 8.

Optionally, the system 2 comprises a water temperature control system that is configured to control the water temperature underneath the to-be-harvested duckweed 10 in a pre-harvest location immediately prior to the harvesting system 8 and/or underneath the harvesting system 8. The data processing system 100 may be configured to control the water temperature control system by sending appropriate control signals.

The system 2 for cultivating duckweed also comprises an illumination system 6. In the depicted embodiment, the illumination system 6 comprises a plurality of light sources 6a-6l, which may also be referred to as luminaires. These light sources may be configured to generate grow light and/or pre-harvest light that is provided to the duckweed.

Growing duckweed may require relatively low light intensities (100-200 μmol/m²/s).

Preferably, each light source is controllable, in that a radiant power and/or electromagnetic spectrum of light emitted by each light source can be separately controlled, for example by receiving control signals from data processing system 100. In the embodiment of FIG. 1A light source 6f is positioned such that it illuminates to-be-harvested duckweed 10 in a pre-harvest location immediately prior to the harvesting system. Light source 6f is in this example positioned near the harvesting system 8.

The system 2 also comprises a duckweed properties measurement system configured to measure one or more properties of the to-be-harvested duckweed in the form of an imaging system 12 and a second data processing system (not shown) which may or may not be embodied within data processing system 100. In any case, the imaging system 12 is configured to capture an image of the to-be-harvested duckweed 10. The second data processing system can then perform image analysis on the captured image to determine one or more characteristics of the to-be-harvested duckweed 10, such as an amount, size, color, or morphology of the to-be-harvested duckweed 10. To this end, the second data processing system may be configured to perform image analysis techniques well known in the art.

Measuring in-situ concentrations of chlorophyl, carotenoids, and flavonoids in duckweed can be done conveniently by measuring the reflection of light at specific wavelengths. A calibrated relation between the measured reflections provides an estimation of the concentration. For example, the so-called chlorophyl-carotenoid index (CCI) is a measure of both the chlorophyl and carotenoid content (they are highly correlated). It involves measuring the reflection of LED light from duckweed at wavelengths of 532 nm and 630 nm. The CCI equals (R₅₃₂-R₆₃₀)/(R₅₃₂+R₆₃₀). Here, R denotes the measured reflectance. Note that the CCI can also be measured in transmission. (See also: Sasagawa T, Akitsu T K, Ide R, Takagi K, Takanashi S, Nakaji T, Nasahara K N. Accuracy Assessment of Photochemical Reflectance Index (PRI) and Chlorophyll Carotenoid Index (CCI) Derived from GCOM-C/SGLI with In Situ Data. Remote Sensing. 2022; 14(21): 5352. https://www.doi.org/10.3390/rs14215352 ).

Alternatively, the chlorophyl concentration is obtained from the following relation: Chl˜(R_{NIR}/R_{Green})−1. Here, the wavelength of green is in the range 540 nm-560 nm while the wavelength of NIR is in the range 760 nm-800 nm. Similarly, for the carotenoid concentration: Car˜((1/R₅₁₅)−(1/R₅₆₅))*RNIR. (See also: Gitelson A A, Keydan G P, Merzlyak M N. Three-band model for non-invasive estimation of chlorophyll, carotenoids, and anthocyanin contents in higher plant leaves. Geophys Res Lett. 2006; 33(11):1-5)

The flavonoid concentration can be obtained from the following relation: Flav˜log (NIR_{red}/NIR_{UVA}). Here, NIR_{red} is the measured fluorescence in the near-infrared (around 730 nm) generated by excitation with red light (e.g., 630 nm). NIR_{UVA} is the fluorescence in the near-infrared (around 730 nm) generated by excitation with UVA light (e.g., 380 nm). (See also: Flavonol, Anthocyanin, and Chlorophyll Indices using a Force-A Dualex Scientific https://www. protocols. io/view/flavonol-anthocyanin-and-chlorophyll-indices-using-yxmvm73×9v3p/v1)

An alternative to the method sketched above, is to take samples of duckweed and analyse them in the laboratory, e.g., using techniques such as HPLC (high performance liquid chromatography).

It should be appreciated that an imaging system is optional. The duckweed properties measurement system may additionally or alternatively comprise a scale, for example to measure a weight of a sample of the to-be-harvested duckweed layer, in order to determine the amount of to-be-harvested duckweed 10.

Once the characteristics of the to-be-harvested duckweed have been measured, the second data processing system can determine duckweed properties based on these measured characteristics. Non-limiting examples of duckweed properties are:
a thickness of the duckweed layer,
an amount, e.g., a number, of duckweed plants per surface area,
a morphology of the to-be-harvested duckweed,
a size or size distribution of the to-be-harvested duckweed,
a texture of the to-be-harvested duckweed,
an amount of chlorophyll in the to-be-harvested duckweed,
an amount of carotenoid in the to-be-harvested duckweed,
an amount of flavonoid in the to-be-harvested duckweed.

These properties are important as, what an effective pre-harvest light recipe is for some the to-be-harvested duckweed 10 depends on these properties of the to-be-harvested duckweed.

Data processing system 100 is configured to determine an appropriate pre-harvest light recipe based on the determined one or more properties of the to-be-harvested duckweed. A pre-harvest light treatment as referred to herein may be a light recipe that is configured to increase the nutritional content of the to-be-harvested duckweed. In particular, a pre-harvest light recipe may be aimed at providing stress to the duckweed plants, in order to invoke a response such as an increased production of nutritional compounds such as proteins with a desired amino acid composition.

After determination of the pre-harvest light recipe, the data processing system 100 can control the illumination system 6, in particular light source 6f of illumination system 6, to illuminate the to-be-harvested duckweed 10 in accordance with the determined pre-harvest light recipe. In the depicted embodiment, only light source 6f is caused to generate light in accordance with the pre-harvest light recipe, since, in the depicted embodiment, only light source 6f illuminates the to-be-harvested duckweed 10, whereas the other light sources 6a-6e and 6g-6l illuminate the other duckweed in system 2. These other light sources may for example generate grow light, which may also be referred to as supplemental light (as supplemental to for example daylight).

In an embodiment, the to-be-harvested duckweed 10 flows from the pre-harvest location further into harvesting system 8, which may be embodied as a sieve, where the to-be-harvested duckweed is harvested. It should be appreciated that for the to-be-harvested duckweed, the properties and characteristics of the to-be-harvested duckweed-in FIG. 1A the duckweed 10 that is present in the pre-harvest location-may change continuously as a result of a continuous flow an mixing of mature duckweed with of young duckweed in the system and the variability in growth (rate) and reproduction (rate) of duckweed, e.g., as a result of varying environmental conditions such as light and temperature. It could very well be that at a first point in time, the to-be-harvested duckweed is very dense, which perhaps would require a higher radiant power to be used for the pre-harvest light, while at a second point in time, the to-be-harvested duckweed is very thin as a consequence of which lower radiant power for the pre-harvest light may be suitable. Thus, preferably, the methods disclosed herein for determining a pre-harvest light recipe based on measured one or more duckweed properties and causing the to-be-harvested duckweed to be illuminated accordingly is performed repeatedly, for example every hour, or every 30 minutes.

In an alternative embodiment, the duckweed does not flow through the system 2, yet remains steady, e.g., with respect to the outer wall 5. In such embodiment, the harvesting system 8 may be configured to move across the water surface 4, e.g., move with respect to outer wall 5, in order to harvest duckweed at different locations within the system 2. In such embodiment, preferably, the imaging system 12 also moves with the harvesting system 8. Even more preferred would be that light source 6f, which is understood to generate illumination in accordance with the pre-harvest light recipe, would also move with the harvesting system 8, for example in the sense that the harvesting system 8, imaging system 12 and light source 6f of the illumination system have a fixed position with respect to each other. In such embodiment, the separation wall 7 in the middle can be left out so that the harvesting system 8 can move around more freely. Alternatively, the function of providing pre-harvest light by a moving light source 6f may be taken over by stationary luminaires closest to the moving harvesting system.

FIG. 1B schematically illustrates another embodiment of the system 2 for cultivating duckweed. In this embodiment a continuous round trip flow is used. As with the embodiment shown in FIG. 1A, the system 2 comprises a shallow layer of water 4 with duckweed floating on top. The water 4 is made to move in a circular manner as indicated by the arrows, e.g., by pumps (not shown), taking the duckweed along at a certain speed that may or may not be constant. After each round trip, a fraction of the duckweed, namely the fraction that passes through passage 20, is harvested by a harvesting system 8, e.g., by an apparatus that automatically skims off the duckweed. The remainder of the duckweed, namely the fraction of the duckweed that passes through passage 22, makes a further round trip. During each round trip, the duckweed grows and propagates.

In this embodiment, the to-be-harvested duckweed is the duckweed that has entered passage 20, because it is this duckweed that is going to be (inevitably) harvested in the near future. The duckweed that passes through passage 22 goes another round and is thus considered “other duckweed” as referred to above.

In any case, the duckweed properties measurement system is configured to measure the properties of specifically the duckweed that is passing through passage 20. To this end, the duckweed properties measurement system may comprise an imaging system 12 that is configured to capture an image of specifically the to-be-harvested duckweed, i.e., the duckweed that is passing through passage 20. In any case, based on the measured properties of the duckweed passing through passage 20, the data processing system 100 determines an appropriate pre-harvest light recipe, which the illumination system 6 can then specifically provide to the to-be-harvested duckweed.

In the embodiment of FIG. 1B, the illumination system comprises a plurality of light sources 6a-6p. However, only light source 6p is configured to, e.g., is positioned to, illuminate duckweed that is passing through passage 20. In particular, in the depicted embodiment, the light source 6p is configured to illuminate the to-be-harvested duckweed indicated by reference number 10. The other light sources of the illumination system, including light sources 6m, 6n, 6o, which are configured to illuminate the duckweed that is passing through passage 22, do not emit light in accordance with the determined pre-harvest light recipe. These light sources may generate regular grow light, also referred to as supplemental light.

The duckweed growth system setup according to FIGS. 1A and 1B are also known as a “raceway”.

Supplemental light is for example beneficial in a multi-layer vertical farm setting (implying there is no daylight) or in a greenhouse setting during times of the year that there is insufficient daylight, or in a multi-layer greenhouse setting were all or some of the layers receive insufficient daylight.

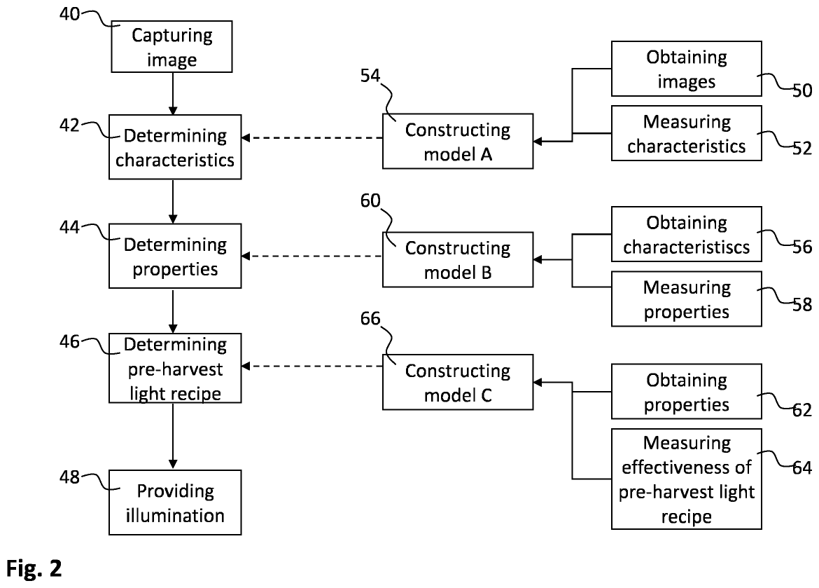

FIG. 2 is a flow chart illustrating a method according to an embodiment. Herein, step 40 comprises capturing an image of the to-be-harvested duckweed. This step may for example be embodied by imaging system 12 taking a photograph of duckweed that is passing through passage 20 as shown in the embodiment of FIG. 1B.

Then, step 42 comprises determining one or more characteristics of the to-be-harvested duckweed, wherein the one or more characteristics comprise at least one of
an amount of the to-be-harvested duckweed,
a size of the to-be-harvested duckweed,
a color of the to-be-harvested duckweed.

Thereafter, step 44 is performed which comprises determining one or more properties based on the one or more characteristics. The one or more duckweed properties referred to herein comprise at least one of
a thickness of the duckweed layer,
an amount, e.g., a number, of duckweed plants per surface area,
a morphology of the to-be-harvested duckweed,
a size or size distribution of the to-be-harvested duckweed,
a texture of the to-be-harvested duckweed,
an amount of chlorophyll in the to-be-harvested duckweed,
an amount of carotenoid in the to-be-harvested duckweed,
an amount of flavonoid in the to-be-harvested duckweed.

Step 42 and step 44 may be performed by a data processing system of a duckweed properties measurement system. However, such data processing system may be the same data processing system 100 that is configured to determine a pre-harvest light recipe. Step 46 comprises, based on the measured one or more properties of the to-be-harvested duckweed, determining a pre-harvest light recipe.

Then, step 48 comprises causing an illumination system to illuminate the to-be-harvested duckweed in accordance with the determined pre-harvest light recipe.

Steps 50-66 show optional steps. In particular, step 54 indicates that a model “A” may be constructed, e.g., using machine learning methods known in the art, and that model A may be used in step 42 in which the characteristics of the to-be-harvested duckweed are determined. Model A may be understood to associate respective images of duckweed on one side with respective sets of one or more duckweed characteristics on the other side. Thus, the model allows to determine, given an image of duckweed, a set of one or more characteristics of that duckweed.

As indicated, model A may be constructed using machine learning methods known in the art. Such machine learning methods typically use training data for model construction and steps 50 and 52 indicate how these training data may have been obtained for the construction of model A. Herein, step 50 comprises, for each batch of duckweed out of a plurality of batches, obtaining images of the batch in question and step 52 comprises measuring characteristics of the batch in question. The latter step may be performed by a human observer who, for each image, analyzes it and inputs a set of values of one or more characteristics into a system in association with the image in question. Herewith, the training data for constructing model A is obtained.

Likewise, step 60 indicates that a model “B” may be constructed, e.g., using machine learning methods known in the art, and that model B may be used in step 44 in which the one or more properties of the to-be-harvested duckweed are determined. Model B may be understood to associate respective sets of characteristics of duckweed on one side with respective sets of one or more duckweed properties on the other side. Thus, the model allows to determine, given a set of duckweed characteristics, a set of one or more properties of that duckweed.

As indicated, model B may be constructed using machine learning methods known in the art. Such machine learning methods typically use training data for model construction and steps 56 and 58 indicate how these training data may have been obtained for the construction of model B. Herein, step 56 comprises for each batch out of a plurality of batches of duckweed, obtaining a set of one or more characteristics of the batch in question and step 58 comprises measuring one or more properties the batch in question. These steps may be performed by a human observer who, for each batch, analyzes its set of one or more characteristics and its set of one or more properties and inputs these two sets into a system in association with each other. Herewith, the training data for constructing model B is obtained.

Likewise, step 66 indicates that a model “C” may be constructed, e.g., using machine learning methods known in the art and that model C may be used in step 46 in which the pre-harvest light-recipe is determined. Model C may be understood to associate respective sets of properties of duckweed on one side with respective pre-harvest light recipes on the other side. Thus, the model allows to determine, given a set of duckweed properties, an appropriate pre-harvest light recipe for that set of properties.

As indicated, model C may be constructed using machine learning methods known in the art. Such machine learning methods typically use training data for model construction and steps 62 and 64 indicate how these training data may have been obtained for the construction of model C. Herein, step 62 comprises obtaining, for each of a plurality of batches of duckweed, a set of one or more properties of the batch in question and step 64 comprises measuring an effectiveness of the pre-harvest light recipe that has been applied to the batch in question. The latter step may be performed by taking a sample of the batch before and after the pre-harvest light recipe has been applied and performing laboratory tests in order to determine the nutritional content increase of the duckweed during the application of the pre-harvest light recipe. Then, for each batch, its set of one or more properties, the pre-harvest light recipe applied and the effectiveness of the pre-harvest light recipe may be input into a system in association with each other. Herewith the training data for constructing model C are obtained.

The machine learning methods referred to in this disclosure are optionally supervised machine learning methods.

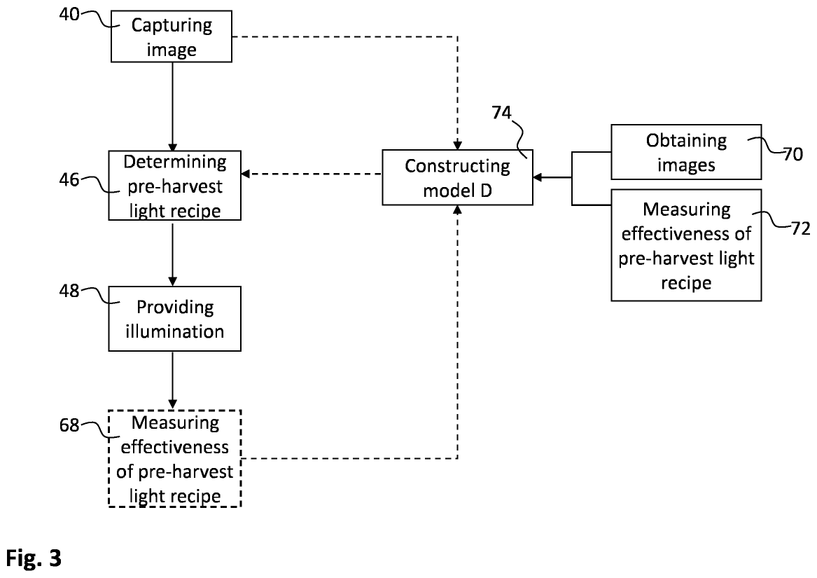

FIG. 3 is a flow chart illustrating another embodiment of the method for cultivating duckweed. Herein, steps 40, 46 and 48 have been described with reference to FIG. 2. Step 68 comprises measuring an effectiveness of the pre-harvest light recipe, for example as described above.

Further, FIG. 3 illustrates that a single model “D” may be used for determining an appropriate pre-harvest light recipe based on a captured image. Model D may also be constructed, e.g., using machine learning methods known in the art. Model D may be understood to associate respective images of to-be-harvested duckweed on one side with respective pre-harvest light recipes on the other side. Thus, the model allows to determine, given an image of to-be-harvested duckweed, an appropriate pre-harvest light recipe for that to-be-harvested duckweed.

As indicated, model D may be constructed using machine learning methods known in the art. Such machine learning methods typically use training data for model construction and steps 70 and 72 indicate how these training data may have been obtained for the construction of model D. Herein, step 70 comprises obtaining, for each of a plurality of batches of to-be-harvested duckweed, an image of the duckweed in question and step 72 comprises measuring an effectiveness of the pre-harvest light recipe that has been applied to the batch in question. The latter step may be performed by taking a sample of the batch before and after the pre-harvest light recipe has been applied and performing laboratory tests in order to determine the nutritional content increase of the duckweed during the application of the pre-harvest light recipe. Then, for each batch of to-be-harvested duckweed, its image, the pre-harvest light recipe applied and the effectiveness of the pre-harvest light recipe may be input into a system in association with each other. Herewith the training data for constructing model D are obtained.

FIG. 3 also shows that model D may be continuously refined. The image that is captured in step 40 may be stored in association with the effectiveness of the pre-harvest light recipe and in association with the pre-harvest light recipe itself. As such, these data may be used to enrich the training data and/or to improve model D.

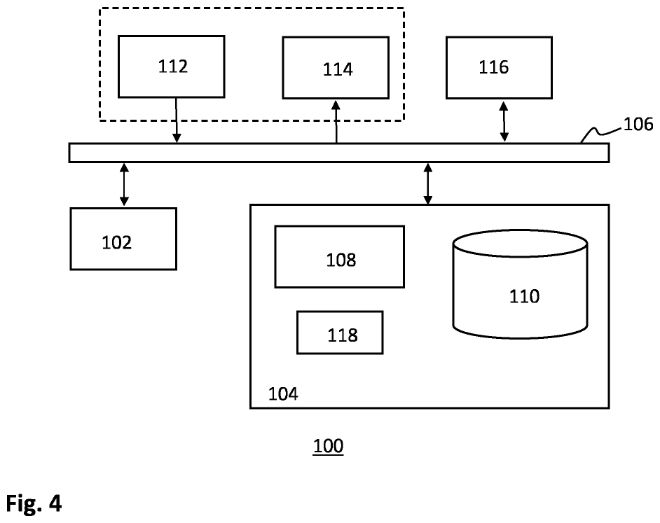

FIG. 4 depicts a block diagram illustrating a data processing system according to an embodiment.

As shown in FIG. 4, the data processing system 100 may include at least one processor 102 coupled to memory elements 104 through a system bus 106. As such, the data processing system may store program code within memory elements 104. Further, the processor 102 may execute the program code accessed from the memory elements 104 via a system bus 106. In one aspect, the data processing system may be implemented as a computer that is suitable for storing and/or executing program code. It should be appreciated, however, that the data processing system 100 may be implemented in the form of any system including a processor and a memory that is capable of performing the functions described within this specification.

The memory elements 104 may include one or more physical memory devices such as, for example, local memory 108 and one or more bulk storage devices 110. The local memory may refer to random access memory or other non-persistent memory device(s) generally used during actual execution of the program code. A bulk storage device may be implemented as a hard drive or other persistent data storage device. The processing system 100 may also include one or more cache memories (not shown) that provide temporary storage of at least some program code in order to reduce the number of times program code must be retrieved from the bulk storage device 110 during execution.

Input/output (I/O) devices depicted as an input device 112 and an output device 114 optionally can be coupled to the data processing system. Examples of input devices may include, but are not limited to, a keyboard, a pointing device such as a mouse, a touch-sensitive display, an imaging system or the like. Examples of output devices may include, but are not limited to, a monitor or a display, speakers, the illumination system described herein, water temperature control system described herein, or the like. Input and/or output devices may be coupled to the data processing system either directly or through intervening I/O controllers.

In an embodiment, the input and the output devices may be implemented as a combined input/output device (illustrated in FIG. 4 with a dashed line surrounding the input device 112 and the output device 114). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display. A network adapter 116 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 100, and a data transmitter for transmitting data from the data processing system 100 to said systems, devices and/or networks. Modems, cable modems, and Ethernet cards are examples of different types of network adapter that may be used with the data processing system 100.

As pictured in FIG. 4, the memory elements 104 may store an application 118. In various embodiments, the application 118 may be stored in the local memory 108, the one or more bulk storage devices 110, or apart from the local memory and the bulk storage devices. It should be appreciated that the data processing system 100 may further execute an operating system (not shown in FIG. 4) that can facilitate execution of the application 118.

The application 118, being implemented in the form of executable program code, can be executed by the data processing system 100, e.g., by the processor 102. Responsive to executing the application, the data processing system 100 may be configured to perform one or more operations or method steps described herein.

FIG. 4 may represent the data processing system described herein that is configured to determine the pre-harvest light recipe. Additionally or alternatively, the FIG. 4 may represent the second data processing system described herein.

In another aspect, the data processing system 100 may represent a client data processing system. In that case, the application 118 may represent a client application that, when executed, configures the data processing system 100 to perform the various functions described herein with reference to a “client”. Examples of a client can include, but are not limited to, a personal computer, a portable computer, a mobile phone, or the like.

In yet another aspect, the data processing system 100 may represent a server. For example, the data processing system may represent an (HTTP) server, in which case the application 118, when executed, may configure the data processing system to perform (HTTP) server operations.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 102 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for cultivating duckweed in a duckweed growth system configured to cause a flow of duckweed through the duckweed growth system, the system comprising:
an illumination system that is configured to illuminate to-be-harvested duckweed, at a location immediately preceding a location of a harvesting system of the duckweed growth system in a duckweed flow direction of the duckweed growth system, the location being a pre-harvest area, and
a duckweed properties measurement system that is configured to measure and/or
determine one or more properties of the to-be-harvested duckweed, and
a data processing system that is configured to:
based on the measured and/or determined one or more properties of the to-be-harvested duckweed, determine a pre-harvest light recipe, and
cause the illumination system to illuminate the to-be-harvested duckweed with pre-harvest light during a pre-harvest phase in accordance with the determined pre-harvest light recipe, wherein the pre-harvest light is different from growth light for stimulating growth of the duckweed in a growth phase prior to the pre-harvest phase and wherein the pre-harvest area is different from a growth area where the duckweed may receive the growth light.

2. The system according to claim 1,
wherein the to-be-harvested duckweed is present as a duckweed layer on a water surface,
wherein the one or more properties comprise at least one of:
a thickness of the duckweed layer,
an amount, e.g., a number, of duckweed plants per surface area,
a morphology of the to-be-harvested duckweed,
a size or size distribution of the to-be-harvested duckweed,
a texture of the to-be-harvested duckweed,
an amount of chlorophyll in the to-be-harvested duckweed,
an amount of carotenoid in the to-be-harvested duckweed, and
an amount of flavonoid in the to-be-harvested duckweed.

3. The system according to claim 1, further comprising a harvesting system that is configured to harvest the to-be-harvested duckweed, wherein the data processing system is configured to cause the harvesting system to harvest the to-be-harvested duckweed after the to-be-harvested duckweed has been illuminated in accordance with the pre-harvest light recipe.

4. The system according to claim 1,
wherein the illumination system is configured to not illuminate other duckweed other than the to-be-harvested duckweed, and/or
wherein the data processing system is configured to cause the illumination system to not illuminate other duckweed other than the to-be-harvested duckweed in accordance with the pre-harvest light recipe.

5. The system according to claim 1, wherein the duckweed properties measurement system comprises an imaging system that is configured to capture an image of the to-be-harvested duckweed and wherein the duckweed properties measurement system comprises a second data processing system that is configured to determine the one or more properties of the duckweed based on the captured image.

6. The system according to claim 5,
wherein the second data processing system is configured to determine, based on the captured image, one or more characteristics of the to-be-harvested duckweed,
wherein the one or more characteristics comprise at least one of:
an amount of the to-be-harvested duckweed,
a size of the to-be-harvested duckweed, and
a color of the to-be-harvested duckweed, and
wherein the second data processing system is configured to:
determine the one or more properties based on the one or more characteristics.

7. The system according to claim 1, wherein the pre-harvest light recipe defines, for a particular time period, one or more properties of light provided to the to-be-harvested duckweed, wherein the one or more properties of light comprise at least one of:
a radiant power of the light as generated by the illumination system, and
a radiant power of the light as received by the to-be-harvested duckweed,
an electromagnetic spectrum of the light generated by the illumination system, and
a variation of the radiant power and/or the radiant flux and/or the electromagnetic spectrum within the particular time period.

8. The system according to claim 7, wherein the data processing system is configured to cause the illumination system to generate light such that the light has the radiant power and/or the radiant flux and/or the electromagnetic spectrum and/or the variation as defined by the pre-harvest light recipe.

9. The system according to claim 1, wherein the system comprises a water temperature control system that is configured to control a temperature of water on which and/or in which the to-be-harvested duckweed is floating, wherein the data processing system is configured to, based on the determined pre-harvest light recipe, determine a temperature for the water below the to-be-harvested duckweed and to cause the water temperature control system to cause the water to have the determined temperature.

10. The system according to claim 1,
wherein the data processing system is configured to determine the pre-harvest light recipe based on the one or more properties using a model, obtainable by performing a machine-learning method, wherein the model associates sets of duckweed properties with respective pre-harvest light recipes.

11. The system according to claim 10, wherein the data processing system is configured to construct the model based on training data, wherein the training data associate a plurality of sets of one more duckweed properties to respective pre-harvest light recipes.

12. A computer-implemented method for illuminating to-be-harvested duckweed in a duckweed growth system configured to cause a flow of duckweed through the duckweed growth system, the duckweed growth system comprising an illumination system that is configured to illuminate to-be-harvested duckweed at a location immediately preceding a location of a harvesting system of the duckweed growth system in a duckweed flow direction of the duckweed growth system, the location being a pre-harvest area, and a duckweed properties measurement system that is configured to measure and/or determine one or more properties of the to-be-harvested duckweed the method comprising:
receiving from the duckweed properties measurements system, a signal indicative of one or more properties of the to-be-harvested duckweed, and
determining, based on the one or more properties of the to-be-harvested duckweed as indicated by the signal, a pre-harvest light recipe, and
causing the illumination system to illuminate the to-be-harvest duckweed with pre-harvest light during a pre-harvest phase in accordance with the determined pre-harvest light recipe,
wherein the pre-harvest light is different from growth light for stimulating growth of the duckweed in a growth phase prior to the pre-harvest phase and wherein the pre-harvest area is different from a growth area where the duckweed may receive the growth light.

13. The computer-implemented method according to claim 12, wherein the to-be harvested duckweed is present as a duckweed layer on a water surface, wherein the one or more properties comprise at least one of:
a thickness of the duckweed layer,
an amount, e.g., a number, of duckweed plants per surface area,
a morphology of the to-be-harvest duckweed,
a size or size distribution of the to-be-harvest duckweed,
a texture of the to-be-harvested duckweed,
an amount of chlorophyll in the to-be-harvested duckweed,
an amount of carotenoid in the to-be-harvested duckweed, and
an amount of flavonoid in the to-be-harvested duckweed.

14. A non-transitory computer readable medium comprising instructions which, when executed by a computer, cause the computer to perform the method according to claim 12.

15. (canceled)
